(19) United States
(12) Patent Application Publication
(10) Pub. No.: US 2004/0108499 A1
(43) Pub. Date: Jun. 10, 2004

(54) Winch drive assembly

(76) Inventor: William Strom, Monte Carlo (MC)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/276,496

(22) PCT Filed: May 17, 2001
(86) PCT No.: PCT/GB01/02167

(30) Foreign Application Priority Data
May 18, 2000 (GB) 0012059.2

(51) Int. Cl. B66D 1/12

(52) U.S. Cl. 254/362

(57) ABSTRACT

A winch drive assembly comprises a motor-driven winch drive (1) drivably engageable with a winch (11) and a laterally-outwardly extending member (4) attached to the winch drive (1), the laterally-outwardly extending member (4) being engageable with a stop for hindering or preventing rotation of the winch drive (1) during driving of the winch (11).

The present invention relates to a winch drive assembly, particularly for a boat or a yacht.

Winches are commonly used on yachts and other boats for tensioning or pulling running rig, usually a line wound around the drum of the winch. The winch can be rotated manually, and a standard shaped socket is provided on the top of the winch for this purpose. A correspondingly shaped bit on a handle is inserted into this standard shaped socket to effect rotation of the winch. Rotation of the winch tightens the line.

It is also possible to effect rotation of the winch using a powered winch drive. Such a winch drive also has a bit shaped to fit the shaped socket on the top of the winch. Portable powered winch drives, such as the winch drive of UK patent application GB-A-2 317 844 are particularly convenient. In order to prevent the main body of the powered winch drive from rotating during driving of the winch, the winch drive is provided with a handle. The operator of the powered winch drive must hold the handle of the powered winch drive as it drives the winch to prevent rotation of the main body of the winch drive. This is inconvenient for the operator. Holding the handle to prevent rotation of the winch drive also requires considerable strength.

An object of the present invention is to provide a winch drive assembly, which does not require manual operation during driving of the winch.

The invention provides a winch drive assembly as claimed in claim 1.

The stop means is preferably a line which is being wound by the winch. In a preferred embodiment of the invention the laterally-outwardly extending member extends substantially radially of the longitudinal axis of the winch drive. The laterally-outwardly extending member is preferably substantially L-shaped. In a further embodiment of the invention the laterally-outwardly extending member comprises at least two parts. In a preferred embodiment of the invention the laterally-outwardly extending member is detachable from the winch drive. The laterally-outwardly extending member preferably has retaining means for holding the stop means. These retaining means are preferably in the form of a foot. The laterally-outwardly extending member can preferably be raised to enable the winch to be driven in the manner of a windlass.

In a preferred embodiment of the invention the winch drive assembly has a self-tailing device. The self-tailing device preferably comprises two annular bodies movable apart against a resilient bias to hold line passed therebetween. In a preferred embodiment of the invention the self-tailing device includes a line guide for guiding the line between the annular bodies.

The shaped bit on the winch drive is preferably integral with the winch drive. In a preferred embodiment of the invention the winch drive is battery driven. The winch drive preferably has battery recharging means. In a further embodiment of the invention the winch drive has a detachable battery housing.

The winch drive preferably has means for reversing the direction of drive of the bit. In a further embodiment of the invention the winch drive has torque and/or speed control.

In a preferred embodiment of the invention the winch drive is controlled remotely.

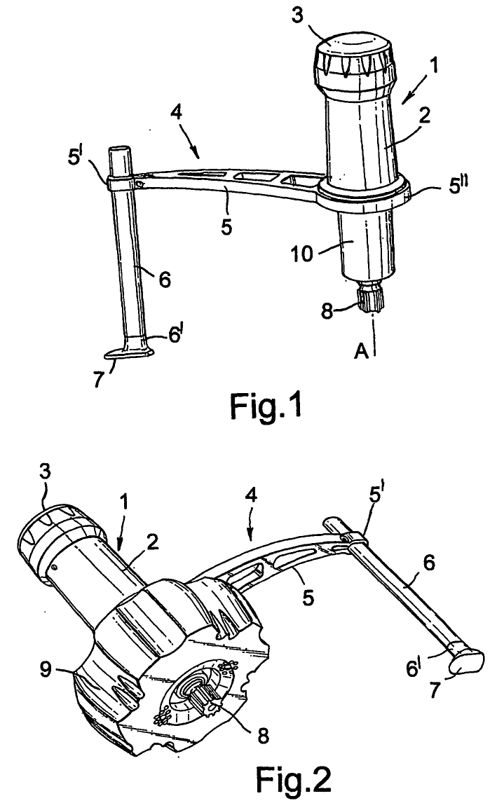

FIG. 1 is a perspective view of a first embodiment of a winch drive assembly in accordance with the invention;

FIG. 2 is a perspective view of a second embodiment of a winch drive assembly in accordance with the invention, and

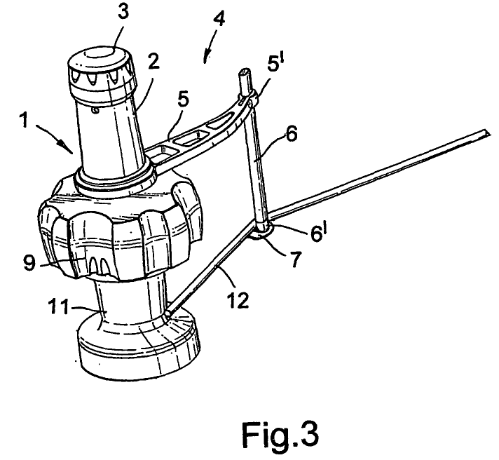

FIG. 3 is a perspective view of the winch drive assembly of FIG. 2 attached to a winch.

In FIG. 1 a winch drive assembly has a winch drive 1 having a substantially cylindrical main body 2 housing an electric motor (not shown), a starting button 3 and a laterally-outwardly extending member 4. The starting button 3 is arranged at the top of the main body 2. The laterally-outwardly extending member 4 is L-shaped and comprises an arm 5 and engaging means in the form of a leg 6, the end 6¹ of the leg 6 remote from the arm 5 having retaining means in the form of a foot 7. The leg 6 is arranged parallel to the longitudinal axis A of the winch drive 1 and is slidably located in a ring-shaped end 5¹ of arm 5, which is arranged perpendicular to the longitudinal axis A of the winch drive 1. The end 5¹¹ of the arm 5 is formed as a ring to enable the arm to be slid over the main body 2 of the winch drive for attachment thereto in the manner of a push-fit. The slidable location of the leg 6 in the end 5¹ and of the end 5¹¹ of the arm 5 on the main body 2 enables the height of the foot and the laterally-outwardly extending member to be adjusted respectively. A shaped bit 8 protrudes from the bottom of the main body 2 of the winch drive 1. In the present embodiment the bit 8 is attached to the winch drive 1.

The winch drive 1 in FIG. 2 is similar to that shown in FIG. 1 but is fitted with a detachable battery pack 9 in a region 10 of the main body 2 below the laterally-outwardly extending member 4. The battery pack 9 is formed as a ring, the inner diameter of the ring being substantially the same as the outer diameter of the region 10 of the main body 2. The shaped bit 8 protrudes beyond the battery pack 9. The battery/ies (not shown) in the battery pack 9 is/are rechargeable.

In use, the winch drive 1 is placed on top of a winch 11, as shown in FIG. 3, so that the shaped bit 8 engages a correspondingly shaped socket (not shown) on the top of the winch 11. Line 12 to be wound by the winch is wound around the winch 11. The height of the leg 6 is adjusted so that the foot 7 is approximately level with the line 12. The height of the leg 6 can be adjusted by sliding the leg 6 in the ring-shaped end 5¹ of the arm 5 or by sliding the arm 5 along the main body 2 of the winch drive 1. When the height has been adjusted retaining means (not shown) are used to hold the leg 6 in the selected position. The leg 6 engages the line 12 so that the main body 2 of the winch drive 1 is prevented from rotation when driving of the winch 11 is initiated. Driving of the winch 11 is initiated by pressing down on the starting button 3. When the operator has pressed the starting button 3 the motor is activated and the shaped bit 8 rotates so as to cause the winch 11, engaged therewith, to rotate. The engagement of the line 12 by the leg 6 prevents the main body 2 of the winch drive 1 from rotating, so that the operator does not have to hold the main body 2 of the winch drive 1 during driving of the winch 11. The foot 7 holds the line 12 against the leg 6. The foot 7 additionally serves to guide the line 12. Any residual slack in the line is taken up by the leg 6. If required, the laterally-outwardly extending member 4 could also be raised away from the line 12 to enable the winch drive to be driven in the manner of a windlass, for example, for raising an anchor.

The operation of a standard winch is such that when the socket is rotated in one direction the winch rotates at one speed, whereas when the socket is rotated in the opposite direction the winch rotates in the same direction, but at a different speed. The shaped bit 8 of the winch drive 1 is capable of driving in both a clockwise and anti-clockwise direction, so that a change of driving speed of the winch 11 can be effected. The winch drive 1 also has means (not shown) for controlling torque and speed.

In an alternative embodiment of the invention the winch drive 1 could be controlled remotely. The winch drive 1 could also have a self-tailing device to hold the line 12 as it leaves the winch 11. For example, the self-tailing device could comprise two annular bodies movable apart against a resilient bias to hold the line passed therebetween. Such a self-tailing device could also have a line guide for guiding the line between the annular bodies.

In a further embodiment of the invention, the leg 6 and/or the arm 5 could engage any body in the vicinity of the winch to prevent rotation of the main body 2 of the winch drive 1.

Although the laterally-outwardly extending member 4 and battery pack 9 are detachable in the embodiments of FIGS. 2 and 3, it would also be possible to have a battery pack and/or arm which are/is integral with the winch drive 1. Alternatively the laterally-outwardly extending member 4 and/or battery pack 9 could be attached to the winch drive 1 by any standard means of fixation, such as adhesive or welding. Similarly, the shaped bit could be detachable from the winch drive. The laterally-outwardly extending member 4 could comprise one part only.

The motor of the winch drive 1 could be powered by an electric generator located remotely from, for example, under the deck of a boat on which the winch is located, but connected to the winch drive 1, for example, by means of leads. The electric generator remote from the winch drive 1 can take the form of an battery. Alternatively, the motor of the winch drive 1 could be a clockwork motor.

The power supply for the motor of the winch drive 1 could be located in a hollow portion of the winch 11.

1. A winch drive assembly comprising a motor-driven winch drive drivingly engageable with a winch, and a laterally-outwardly extending member attached to the winch drive, the laterally-outwardly extending member being engageable with stop means for hindering or preventing rotation of the winch drive during driving of the winch, wherein the stop means is independent of the winch.

2. A winch drive assembly as claimed in claim 1, wherein the stop means is a line being wound by the winch.

3. A winch drive assembly as claimed in claim 1 or 2, wherein the laterally-outwardly extending member projects substantially radially of the longitudinal axis of the winch drive.

4. A winch drive assembly as claimed in any one of the preceding claims, wherein the laterally-outwardly extending member is substantially L-shaped.

5. A winch drive assembly as claimed in any one of the preceding claims, wherein the laterally-outwardly extending member comprises at least two parts.

6. A winch drive assembly as claimed in any one of the preceding claims, wherein the laterally-outwardly extending member is detachable from the winch drive.

7. A winch drive assembly as claimed in any one of the preceding claims, wherein the laterally-outwardly extending member has retaining means for holding the laterally-outwardly extending member against the stop means.

8. A winch drive assembly as claimed in claim 7, wherein the retaining means is a foot.

9. A winch drive assembly as claimed in any one of the preceding claims, wherein the winch drive includes a self-tailing device.

10. A winch drive assembly as claimed in claim 9, wherein the self-tailing device comprises two annular bodies movable apart against a resilient bias to hold a line passed therebetween.

11. A winch drive assembly as claimed in claim 10, wherein the self-tailing device includes a line guide for guiding the line between the annular bodies.

12. A winch drive assembly as claimed in any one of the preceding claims, wherein the bit is attached to the winch drive.

13. A winch drive assembly as claimed in any one of the preceding claims, wherein the winch drive is battery driven.

14. A winch drive assembly as claimed in claim 13, wherein the winch drive has battery recharging means.

15. A winch drive assembly as claimed in claim 13 or 14, wherein the winch drive has a detachable battery housing.

16. A winch drive assembly as claimed in any one of claims 1-12, wherein the winch drive is driven by an electric generator remote from the winch drive.

17. A winch drive assembly as claimed in any one of the preceding claims, wherein the winch drive has means for reversing the direction of drive of the bit thereby changing the speed of the winch in use.

18. A winch drive assembly as claimed in any one of the preceding claims, wherein the winch drive has a torque and/or speed control.

19. A winch drive assembly as claimed in any one of the preceding claims, wherein the laterally-outwardly extending member may be raised to enable the winch to be driven in the manner of a windlass.

20. A winch drive assembly as claimed in any one of the preceding claims, wherein the winch drive is controlled remotely.

21. A winch drive assembly substantially as herein described with reference to any one of the embodiments shown in the accompanying drawings.
